(19) United States
(12) Patent Application Publication
(10) Pub. No.: US 2007/0096617 A1
(43) Pub. Date: May 3, 2007

(54) Composition for forming insulating layer or electron emission source, and electron emission device including insulating layer or electron emission source formed using the composition

(76) Inventor: Myong-Ik Hwang, Suwon-si (KR)

Correspondence Address: Robert E. Bushnell, Suite 300, 1522 K Street, N.W., Washington, DC, 20005, US

(21) Appl. No.: 11/589,775

(22) Filed: Oct. 31, 2006

(30) Foreign Application Priority Data
Oct. 31, 2005 (KR) 10-2005-0103463

(51) Int. Cl. H01J 9/02

(52) U.S. Cl. 313/310

(57) ABSTRACT

Provided are a composition for forming an insulating layer or an electron emission source, and an electron emission device including an insulating layer or an electron emission source, formed using the composition. By using nano-sized glass frit, an insulating layer having a small thickness and improved uniformity or an electron emission source having improved viscosity and uniformity can be obtained. An electron emission device including the insulating layer or the electron emission source has improved reliability and performance.

### CROSS-REFERENCE TO RELATED PATENT APPLICATIONS AND CLAIM OR PRIORITY

This application claims the benefit of Korean Patent Application No. 10-2005-0103463, filed on Oct. 31, 2005, in the Korean Intellectual Property Office, the disclosure of which is incorporated herein in its entirety by reference.

### BACKGROUND OF THE INVENTION

1. Field of the Invention

The present invention relates to a composition for forming an insulating layer or an electron emission source, and an electron emission device including an insulating layer or an electron emission source formed using the composition. Particularly, by using nano-sized glass frit, an insulating layer having a small thickness and improved uniformity or an electron emission source having improved viscosity and uniformity can be obtained, and an electron emission device including the insulating layer or the electron emission source has improved reliability and performance.

2. Description of the Related Art

In general, electron emission devices can be catalyzed into electron emission devices using hot cathodes as an electron emission source and electron emission devices using cold cathodes as an electron emission source. Examples of electron emission devices using cold cathodes as an electron emission source include field emitter array (FEA) type electron emission devices, surface conduction emitter (SCE) type electron emission devices, metal insulator metal (MIM) type electron emission devices, metal insulator semiconductor (MIS) type electron emission devices, ballistic electron surface emitting (BSE) type electron emission devices etc.

FEA type electron emission devices operate based on a principle that a low work function or high beta function material as an electron emission source easily emits electrons due to an electric charge difference under a vacuum condition. Recently, a tip-shaped structure mainly formed of Mo, Si, etc., a carbonaceous material such as graphite, diamond like carbon (DLC), or the like, and a nano material such as nano tubes, nano wires, or the like have been developed as an electron emission source for FEA type electron emission devices.

In an SCE type electron emission device, a first electrode faces a second electrode on a first substrate, and a conductive thin film having fine cracks is located between the first and second electrodes. These fine cracks are used as an electron emission source. In this structure, when a voltage is applied to the device, current flows in the surface of the conductive thin film and electrons are emitted through fine cracks as an electron emission source.

MIM type electron emission devices and MIS type electron emission devices include an electron emission source having a metal-dielectric layer-metal structure and an electron emission source having a metal-dielectric layer-semiconductor structure, respectively. These devices operate based on a principle that when a voltage is applied between metals or between metal and semiconductor separated by a dielectric layer, electrons move, are accelerated and are emitted from the metal or semiconductor having higher electron electric charge to the metal having lower electron electric charge.

BSE type electron emission devices operate based on a principle that when a semiconductor is miniaturized to a dimension smaller than a mean free path of electrons of the semiconductor, electrons travel without being dispersed. Particularly, an electron supply layer formed of metal or semiconductor is formed on an ohmic electrode, an insulating layer and a metal thin film are formed on the electron supply layer, and a voltage is applied to the ohmic electrode and the metal thin film to emit electrons.

In addition, according to locations of a cathode and a gate electrode, FEA type electron emission devices can be categorized into top gate type electron emission devices and under gate type electron emission devices. Furthermore, according to the number of electrodes used, FEA type electron emission devices can be categorized into diode electron emission devices, triode electron emission devices, tetrode electron emission devices, etc. (See Korean Patent Publication No. 2004-0057420.)

In electron emission devices described above, an insulating layer is conventionally formed of glass frit that is an insulating material. In general, an amorphous glass frit having a size of a minimum of a few microns can be obtained using a conventional mechanical blending technique, and when such glass frit is used to form a thick insulating layer of an electron emission display apparatus, the insulating layer after being sintered is non-uniform and it is difficult to form an insulating layer having a thickness of a few microns.

Glass frit can also be used to provide an adhesive force after a paste is sintered to the paste for an electron emission source of the electron emission device. In this case, since a conventional mechanical blending allows formation of glass frit only having a few micrometers, such large glass frit acts as a foreign material in an electron emission source of a fine-pitch device. As a result, the performance of the device decreases.

### SUMMARY OF THE INVENTION

The present invention provides a composition for forming an insulating layer containing nano-sized glass frit.

The present invention also provides a composition for forming an electron emission source containing nano-sized glass frit.

The present invention also provides an insulating layer formed using the composition for forming an insulating layer.

The present invention also provides an electron emission source formed using the composition for forming an electron emission source.

The present invention also provides an electron emission device including the insulating layer.

The present invention also provides an electron emission device including the electron emission source.

According to an aspect of the present invention, there is provided a composition for forming an insulating layer, including: glass frit having an average particle diameter of nanometers; a dispersant; a solvent; and a binder.

The average particle diameter of the glass frit may be in the range of 1 to 1,000 nm.

The average particle diameter of the glass frit may be in the range of 10 to 100 nm.

The glass frit may be obtained by plasma spraying.

The glass frit may be spherical.

The glass frit includes at least one glass frit selected from the group consisting of PbO—B₂O₃-based glass frit, PbO—B₂O₃—SiO₂-based glass frit, PbO—B₂O₃—SiO₂—Al₂O₃-based glass frit, ZnO—B₂O₃—SiO₂-based glass frit, PbO—ZnO—B₂O₃—SiO₂-based glass frit, Na₂O—B₂O₃—SiO₂-based glass frit, and BaO—CaO—SiO₂-based glass frit, but is not limited thereto.

The dispersant has an amount of 0.01 to 10 parts by weight and the binder has an amount of 1 to 50 parts by weight, based on 100 parts by weight of the glass frit.

The dispersant includes at least one agent selected from the group consisting of anionic surfactant, cationic surfactant, nonionic surfactant, polycarboxylic acid polymer surfactant, a polyetherester acid amine salt, and silane coupling agent.

The binder includes at least one resin selected from the group consisting of a cellulose-based resin such as ethyl cellulose and nitro cellulose; an acryl-based resin such as polyester acrylate, epoxy acrylate, and urethane acrylate; and/or a vinyl-based resin. Particularly, the acryl-based resin may be a homopolymer of a (meth)acrylate compound, a copolymer of at least two kinds of a (meth)acrylate compound, or a copolymer of a (meth)acrylate compound and other copolymerizable monomer.

According to another aspect of the present invention, there is provided a composition for forming an electron emission source, including: glass frit having an average particle diameter of nanometers; a carbonaceous material; and a vehicle.

The carbonaceous material has an amount of 0.1 to 200 parts by weight and the vehicle has an amount of 150 to 2,000 parts by weight, based on 100 parts by weight of glass frit.

The carbonaceous material may be a carbon nanotube.

The vehicle includes a polymer and an organic solvent.

The polymer includes at least one resin selected from the group consisting of a cellulose-based resin such as ethyl cellulose and nitro cellulose; an acryl-based resin such as polyester acrylate, epoxy acrylate, and urethane acrylate; and a vinyl-based resin. The amount of the polymer may be in the range of 5-60 wt % based on the entire weight of the composition for forming an electron emission source.

The organic solvent includes at least one solvent selected from the group consisting of butyl carbitol acetate (BCA), terpineol (TP), toluene, texanol, and butyl carbitol (BC). The amount of the organic solvent may be in the range of 40-80 wt % based on the entire weight of the composition for forming an electron emission source.

The composition for forming an electron emission source may further include at least one selected from the group consisting of an inorganic adhering component, an organic adhering component, and a metal having a low melting point.

The composition for forming an electron emission source may further include at least one selected from the group consisting of filler, a photosensitive resin, a viscosity improver, and a resolution improver.

According to still another aspect of the present invention, there is provided an insulating layer formed using the composition for forming an insulating layer described above.

The thickness of the insulating layer may be in the range of 2 to 10 microns.

According to yet another aspect of the present invention, there is provided an electron emission source formed using the composition for forming an electron emission source described above.

According to another aspect of the present invention, there is provided an electron emission device including: a first substrate; a plurality of cathodes on the first substrate; a plurality of gate electrodes crossing the cathodes, the plurality of cathodes and the plurality of gate electrodes having electron emission source holes at the junctions of the plurality of cathodes and the plurality of gate electrodes; an insulating layer that insulates the cathodes and the gate electrodes; and electron emission sources in the electron emission source holes, wherein at least one of the insulating layer and the electron emission sources contains glass frit having an average particle diameter of nanometers.

### BRIEF DESCRIPTION OF THE DRAWINGS

A more complete appreciation of the present invention, and many of the above and other features and advantages of the present invention, will be readily apparent as the same becomes better understood by reference to the following detailed description when considered in conjunction with the accompanying drawings in which like reference symbols indicate the same or similar components, wherein:

FIG. 1 is a perspective view of an electron emission device and a display apparatus according to an embodiment of the present invention;

FIG. 2 is a sectional view taken along line II-II shown in FIG. 1; and

FIG. 3 is a scanning electron microscope (SEM) image of an insulating layer according to an embodiment of the present invention.

### DETAILED DESCRIPTION OF THE INVENTION

A composition for forming an insulating layer according to an embodiment of the present invention includes glass frit, a dispersant, a solvent, and a binder. The glass frit has an average particle diameter of nanometers (i.e., not greater than 1,000 nm). The glass frit can be obtained by plasma spraying. Preferably, the glass frit having an average particle diameter of nanometers is obtained by melting conventional glass frit using plasma of 300-450° C., and dispersing the melted glass frit at a predetermined rate under a predetermined atmospheric pressure or in a vacuum chamber, thereby forming nanoparticles having an average particle diameter of nanometers. Since the composition for forming an insulating layer according to an embodiment of the present invention includes such nanoparticles, an insulating layer formed using the composition has a small thickness and a uniform nanostructure.

The glass frit can be any glass frit providing an insulating property that is known in the art. For example, the glass frit may include PbO—B₂O₃-based glass frit, PbO—B₂O₃—SiO₂-based glass frit, PbO—B₂O₃—SiO₂-Al₂O₃-based glass frit, ZnO—B₂O₃—SiO₂-based glass frit, PbO—ZnO—B₂O₃—SiO₂-based glass frit, Na₂O—B₂O₃—SiO₂-based glass frit, and BaO-CaO—SiO₂-based glass frit. However, the glass frit is not limited thereto.

The glass frit may be spherical. The glass frit may have an average particle diameter of nanometers, 1 to 1,000 nm, preferably 10 to 100 nm. When the average particle diameter of the glass frit is less than 1 nm, the manufacturing costs may increase significantly. On the other hand, when the average particle diameter of the glass frit is more than 1,000 nm, an insulating layer formed using the glass frit is thick, less planarized, and less uniform. As a result, it may be difficult to manufacture a fine-pitch device.

The dispersant of the composition for forming an insulating layer may be any dispersant that homogeneously disperses the glass frit described above, and can be selected from dispersants known in the art.

For example, the dispersant includes anionic surfactant, cationic surfactant, nonionic surfactant, polycarboxylic acid polymer surfactant, a polyetherester acid amine salt, and/or a silane coupling agent. However, the dispersant is not limited thereto.

In particular, examples of the anionic surfactant may include alkylbenzenesulphonic acid, alkylnaphthalenesulphonic acid sodium salt, alkyl sulfosuccinic acid sodium salt, alkyldiphenyletherdisulfonic acid sodium salt, formalin condensate sodium salt, aromatic sulfonic acid formalin condensate sodium salt, etc. Examples of the cationic surfactant include alkylamine salt, tertiary ammonium salt etc. Examples of the nonionic surfactant include polyethyleneglycolmonolaurate, polyethyleneglycolmonostearate, polyethyleneglycoldistearate, polyethyleneglycol monoolate, lauric acid diethanolamide, decylglucoside, lauryl glucoside etc. Examples of the polycarboxylic acid polymer surfactant include a part ester of α-olefin/anhydrous maleic acid copolymer, aliphatic poly carboxylate, aliphatic polycarboxylic acid speciality silicon etc. Examples of the polyetherester acid amine salt include polyetherester acids such as polyetherpolyester acid and polyetherpolyolpolyester acid, organic amines such as a polymer poly amine etc. Examples of the silane coupling agent include vinyltrimethoxysilane, vinyltriethoxysilane, [symbol] -chloropropyltrimethoxysilane, [symbol] -aminopropyltriethoxysilane, N-beta-(N-vinylbenzylaminoethyl) [symbol] -aminopropyltrimethoxysilane • hydrochloride, N-(beta-aminoethyl) [symbol] -aminopropylmethyldimethoxysilane, γ-glycidoxypropyltrimethoxysilane, beta-glycidoxypropylmethyldimethoxysilane, γ-methacryloxypropyltrimethoxy silane, γ-methacryloxypropylmethyldimethoxysilane, γ-mercaptoproyl trimethoxysilane, γ-(2-aminoethyl) aminopropyltrimethoxysilane, γ-(2-aminoethyl)aminopropylmethyl dimethoxysilane, amino-silane, vinyltriacetoxysilane, γ anilinopropyltrimethoxysilane, octadecyldimethyl (3-(trimethoxysilyl) propyl) ammoniumchloride, γ-ureidopropyltriethoxysilane etc. However, the anionic surfactant, the cationic surfactant, the nonionic surfactant, the polycarboxylic acid polymer surfactant, the polyetherester acid amine salt, and the silane coupling agent are not limited thereto.

The amount of the dispersant may be 0.01 parts by weight to 10 parts by weight, preferably 0.01 parts by weight to 2 parts by weight, based on 100 parts by weight of the glass frit. When the amount of the dispersant is less than 0.01 parts by weight based on 100 parts by weight of the glass frit, efficient dispersion of the glass frit cannot be obtained. On the other hand, when the amount o the dispersant is greater than 10 parts by weight based on 100 parts by weight of the glass frit, viscosity and dispersity of the composition for preparing an insulating layer relatively decreases and thus the insulating property of the insulating layer may decrease.

The binder of the composition for forming an insulating layer attaches an insulating layer to a substrate of an electron emission device, and can be any binder that is known in the art.

Examples of the binder include a cellulose-based resin such as ethyl cellulose and nitro cellulose; an acryl-based resin such as polyester acrylate, epoxy acrylate, and urethane acrylate; a vinyl-based resin etc. Particularly, the acryl-based resin can be a homopolymer of a (meth)acrylate compound, a copolymer of at least two kinds of a (meth)acrylate compound, or a copolymer of a (meth)acrylate compound and other copolymerizable monomer. Examples of the (meth)acrylate compound include a cycloalkyl (meth) acrylate such as dicyclopentenyl (meth) acrylate, dicyclopentadienyl (meth) acrylate, bornyl (meth) acrylate, isobornyl (meth) acrylate, tricyclodecanyl (meth) acrylate, or tetrahydrofurfuryl (meth) acrylate; benzyl (meth)acrylate; tetrahydrofurfuryl(meth)acrylate etc. However, the (meth)acrylate compound is not limited thereto.

The other copolymerizable monomer can be any compound that can be copolymerized with the (meth)acrylate compound. Examples of the other copolymerizable monomer include an instauration carboxylic acid such as (meth) acrylic acid, vinylbenzoic acid, maleic acid, or vinyl phthalic acid; a vinyl group containing radical polymerizable compound such as vinylbenzylmethylether, vinylglyclycidylether, styrene, α-methyl styrene, butadiene, or isoprene etc. However, the other polymerizable monomer is not limited thereto.

The amount of the binder may be in the range of 1 parts by weight to 50 parts by weight based on 100 parts by weight of the glass frit. When the amount of the binder is less than 1 parts by weight based on 100 parts by weight of the glass frit, the viscosity of the composition increases and thus it is difficult to manufacture a green sheet. On the other hand, when the amount of the binder is greater than 50 parts by weight based on 100 parts by weight of the glass frit, the composition shrinks significantly when being sintered, and thus a substrate deformation can occur.

The solvent provides viscosity to the composition for forming a green sheet, thereby increasing the printability of the composition. The solvent can be any material that can be easily mixed with the glass frit, dispersant, and the binder described above, and can be easily dried.

Examples of the solvent include ethers such as diethylether, diisopropylether, dibuthylether, 1,2-dimethoxyethane, tetrahydrofuran, 1,4-dioxane etc; esters such as methyl acetic acid, ethyl acetic acid, propyl acetic acid, butyl acetic acid, methyl lactic acid etc; ketones such as acetone, methylethylketone, methylisobutylketone, diethylketone, cyclohexanone etc: amids such as N,N′-dimethylformamid, N,N′-dimethylacetamid, hexamethylphosphoric acidphosphoroamid, N-methylpyrrolidone etc; lactams such as caprolactam etc; lactones such as γ-lactone, δ-lactone etc; sulfoxides such as dimethylsulfoxide, diethylsulfoxide etc; aliphatic hydrocarbons such as pentane, hexane, heptane, octane, nonane, decane etc; alicyclic hydrocarbons such as cyclopentane, cyclohexane, cycloctane etc; aromatic hydrocarbons such as benzene, toluene, xylene etc; halogenated hydrocarbons such as dichloromethane, chloroform, carbon tetrachloride, 1,2-dichloroethane, chlorobenzene etc; and a mixed solvent of at least two of these. However, the solvent is not limited thereto.

The amount of the solvent may be in the range of 10 parts by weight to 1,000 parts by weight, preferably 100 parts by weight to 400 parts by weight, based on 100 parts by weight of the glass frit. When the amount of the solvent is less than 10 parts by weight based on 100 parts by weight of the glass frit, the composition for forming a green sheet has poor printability. On the other hand, when the amount of the solvent is greater than 1,000 parts by weight based on 100 parts by weight of the glass frit, a drying process for the green sheet is expensive and requires a long time.

The composition for forming an insulating layer may further include a plasticizer.

The plasticizer improves a bending property of a green sheet, and can be polyvinylbutral, glycerin etc.

By using the composition for forming an insulating layer, a thin insulating layer having a thickness of a few micrometers and a uniform nanostructure can be mass produced at low costs. Such an insulating layer can be used in various electronic devices and display apparatus such as an electron emission device and an electron emission display apparatus.

The insulating layer described above may have a thickness of 2 to 5 μm. Such a small thickness is a meaningful improvement considering that a thickness of less than 5 μm cannot be obtained for a conventional insulating layer, for example, an insulating layer formed using a screen printing method. In addition, such improvement can be obtained by controlling the size of the glass frit that will be used to form an insulating layer to nanometers and thus controlling the thickness of the insulating layer.

A composition for forming an electron emission source according to an embodiment of the present invention includes glass frit having an average particle diameter of nanometers. The composition includes glass frit having an average particle diameter of nanometers, a carbonaceous material, and vehicle. The glass frit having an average diameter of nanometers provides excellent adhesiveness to an electron emission device that will be obtained after the composition is pasted and sintered.

The glass frit having an average diameter of nanometers can be obtained by melting glass frit using a low temperature of plasma of 300-450° C. and then ejecting the melted glass frit under an atmospheric pressure or in a vacuum chamber, as described above. The above described glass frit can be used. The average particle diameter of the prepared glass frit may be 1 to 1,000 nm, preferably 10 to 100 nm. When the average particle diameter of the prepared glass frit is less than 1 nm, the manufacturing costs increase significantly. On the other hand, when the average particle diameter of the prepared glass frit is greater than 1,000 nm, the adhering force of the composition after being sintered may decrease.

The carbonaceous material of the composition for forming an electron emission source is directly related to electron emission. In general, a carbon nanotube-containing carbonaceous material is used as the carbonaceous material. The carbon nanotube-containing carbonaceous material has high conductivity and electric field effect, is suitable for low voltage operation due to its low work function and excellent electron emission performance, and can be produced in a large area. Therefore, the carbon nanotube-containing carbonaceous material can be preferably used for an electron emission source forming material for forming an electron emission device.

The amount of the carbonaceous material may be in the range of 0.1 to 200 parts by weight based on 100 parts by weight of the glass frit. When the amount of the carbonaceous material is less than 0.1 parts by weight, sufficient electron emission cannot be obtained. On the other hand, when the amount of the carbonaceous material is greater than 200 parts by weight, the composition for forming an electron emission source may not disperse or cannot be printed.

The vehicle of the composition for forming an electron emission source controls the viscosity or printability of the composition. The amount of the vehicle may be in the range of 150 to 2,000 parts by weight based on 100 parts by weight of the glass frit. When the amount of the vehicle is less than 150 parts by weight, sufficient viscosity and printability cannot be obtained. On the other hand, when the amount of the vehicle is less than 2,000 parts by weight, sufficient adhesiveness cannot be obtained due to the relatively small amount of the glass frit.

The vehicle of the composition for forming an electron emission source may include a polymer and an organic solvent. The polymer component can be, but is not limited to, a cellulose-based resin such as ethyl cellulose and nitro cellulose; an acryl-based resin such as polyester acrylate, epoxy acrylate, and urethane acrylate; or a vinyl-based resin. The amount of the polymer may be in the range of 5-60 wt % based on the entire amount of the composition for forming an electron emission source.

The organic solvent of the vehicle can be, but is not limited to, butyl carbitol acetate (BCA), terpineol (TP), toluene, texanol, or butyl carbitol (BC). The amount of the organic solvent may be in the range of 40 to 80 wt % based on the entire weight of the composition for forming an electron emission source.

The composition for forming an electron emission source according to an embodiment of the present invention may further include, as an adhering component that enhances an adhesive force between carbon nanotube and a substrate, an inorganic adhering component, an organic adhering component, and/or a metal having a low melting point.

In addition, the composition for forming an electron emission source according to an embodiment of the present invention may further include filler, a photosensitive resin, viscosity improver, resolution improver etc. In particular, the filler improves conductivity of carbon nanotubes that are insufficiently adhered to the substrate, and can be, but is not limited to, Ag, Al, or Pd. The photosensitive resin is used when the composition for forming an electron emission source is printed along an electron emission source forming region, and can be, but is not limited to, poly(methyl methacrylate (PMMA), trimethylolpropane triacrylate (TMPTA), or methyl acrylic acid.

When needed, the composition for forming an electron emission source includes a conventional photosensitive monomer; a conventional photo initiator; a photosensitive resin such as polyester acrylate based resins; a non photosensitive polymer such as cellulose, acrylate, or vinyl based compounds; a dispersant; an antifoaming agent etc.

The photosensitive monomer acts as a pattern cracking improver, and can be an acrylate based monomer that is thermally decomposed, a benzophenone-based monomer, an acetphenone based monomer, or thioxanthones based monomer, or the like. In particular, the photosensitive monomer can be epoxy acrylate, polyester acrylate, 2,4-diethyloxantone (2,4-diethyloxanthone), or 2,2-dimetoxy-2-phenylcetophenone. The amount of the photosensitive monomer may be in the range of 3-40 wt % based on the entire amount of the composition.

The photo initiator can be any photo initiator that is conventionally used. The amount of the photo initiator may be in the range of 0.05-10 wt % based on the entire amount of the composition.

The composition for forming an electron emission source described above can be used to form an electron emission source. By using glass frit powder having an average particle diameter of nanometers according to an embodiment of the present invention, an electron emission source that has improved uniformity and improved adhesiveness after being sintered can be obtained.

The insulating layer and/or the electron emission source formed using these compositions described above can be used in an electron emission device. An electron emission device according to an embodiment of the present invention includes: a first substrate; cathodes and electron emission sources formed on the first substrate; gate electrodes that are electrically insulated from the cathodes; and an insulating layer that is interposed between the cathodes and the gate electrodes and insulates the cathodes from the gate electrodes. In this structure, the electron emission sources are formed using the composition for forming an electron emission source according to an embodiment of the present invention, and the insulating layer is formed using the composition for forming an insulating layer according to an embodiment of the present invention.

The electron emission device according to an embodiment of the present invention may further include a second insulating layer that covers upper portions of the gate electrodes. When needed, the electron emission device may further include focus electrodes that are insulated from the gate electrodes by the second insulating layer and disposed parallel to the gate electrodes. The second insulating layer can be formed using the composition for forming an insulating layer according to an embodiment of the present invention.

As for a method of forming an insulating layer using the composition for forming an insulating layer according to an embodiment of the present invention, the composition can be formed in a film, for example, the composition is formed in a sheet having a predetermined pattern and then the prepared sheet is attached to a substrate, and alternatively, the composition can be directly printed on a substrate and then the printed composition is sintered. However, the method of forming an insulating layer is not limited thereto and can be any method that is known in the art.

The method of directly coating the composition for forming an insulating layer on the substrate can be any method that is known in the art. For example, a screen printing method can be used for the direct coating. However, the direct coating method is not limited thereto. Subsequently, the composition attached to the substrate of the electron emission device is sintered so that the solvent is vaporized, some of the binder is thermally decomposed, and some of the glass frit is melted. As a result, an insulating layer is formed. The sintering process may change according to the composition and the thickness of an insulating layer to be formed. For example, the sintering process can be performed at a temperature of 400-600° C. for 5 min.-30 min.

A method of forming an electron emission source using the composition for forming an electron emission source according to an embodiment of the present invention can be a pasting method that is commonly known in the art, but is not limited thereto. For example, a method of forming an electron emission source of an electron emission device according to an embodiment of the present invention using the composition for forming an electron emission source includes: preparing a composition for forming an electron emission source including glass frit having an average particle diameter of nanometers, a carbonaceous material, and a vehicle; printing the composition on a substrate; sintering the printed composition; and activating the sintered product.

First, a composition for forming an electron emission source is prepared by mixing the glass frit described above, a carbonaceous material, a vehicle, optionally an adhering component, and other additives. Before being printed, the composition has a viscosity of 3,000 to 50,000 cps, preferably 5,000 to 30,000 cps.

Then, the composition is printed on a substrate. The “substrate” refers to a substrate on which an electron emission source is to be formed, and the kind of the substrate is determined by an electron emission device to be formed. The substrate is preferably a panel having a predetermined thickness. Examples of the panel include quartz glass, glass that contains an impurity such as a small amount of Na, plate glass, glass substrate coated with SiO₂, and aluminum oxide or ceramic substrate. In addition, in order to manufacture a flexible display apparatus, a flexible plane can be used as the substrate.

The printing method can be selected according to presence of a photosensitive resin in the composition for forming an electron emission source. When the composition includes a photosensitive resin, an additional photoresist pattern is not required. That is, the composition including a photoresist resin is printed to be coated, and then the printed composition is exposed and developed according to an electron emission source forming region.

On the other hand, when the composition does not include a photoresist resin, a photolithography process using a photoresist film patter is required. That is, first, a photoresist film pattern is formed using a photoresist film, and then the composition is printed using the photoresist film pattern.

By sintering the printed composition, the adhesive force between the carbonaceous material and the substrate may increase, durability of the formed electron emission source may increase due to melting and hardening of the binder, and outgassing can be minimized. The sintering temperature is dependent on temperature and time in which the vehicle of the composition can evaporate and the binder can be sintered. A conventional sintering temperature is in the range of 400-500° C., preferably 450° C. When the sintering temperature is less than 400° C., the vehicle is insufficiently evaporated. On the other hand, the sintering temperature is higher than 500° C., the carbon nanocoil can be damaged.

The carbonaceous material at the surface of the sintered product described above, for example, a carbon nanotube is activated. In an activating method according to an embodiment of the present invention, an electron emission source surface treating agent containing a solution that can be formed in a film by thermal treatment, for example, a polyimid based polymer is coated on the sintered product, and then thermally treated. Then, the thermally treated film is peeled. In an activating method according to another embodiment of the present invention, an adhering portion having an adhesive force is formed on the surface of a roller that operates with a predetermined operation source, and then the surface of the sintered product is pressured with the resultant roller with a predetermined pressure. As result of the activation, carbon nanotube can be exposed to the surface of the electron emission source or vertically oriented.

The insulating layer and the insulating layer formed described above can be used in an electron emission device. The electron emission device including the insulating layer and the electron emission source can be used in a wide range of applications such as a backlight unit of LCDs or an electron emission display apparatus.

An electron emission display apparatus including the electron emission device according to an embodiment of the present invention includes: a first substrate, a plurality of cathodes on the first substrate; a plurality of gate electrodes crossing the cathodes; an insulating layer that is interposed between the cathodes and the gate electrode and insulates the cathode electrodes from the gate electrodes; electron emission source holes at the junctions of the cathodes and the gate electrodes, and electron emission sources in the electron emission source holes, a second substrate located substantially parallel to the first substrate, an anode on a second substrate, and a fluorescent layer on the anode.

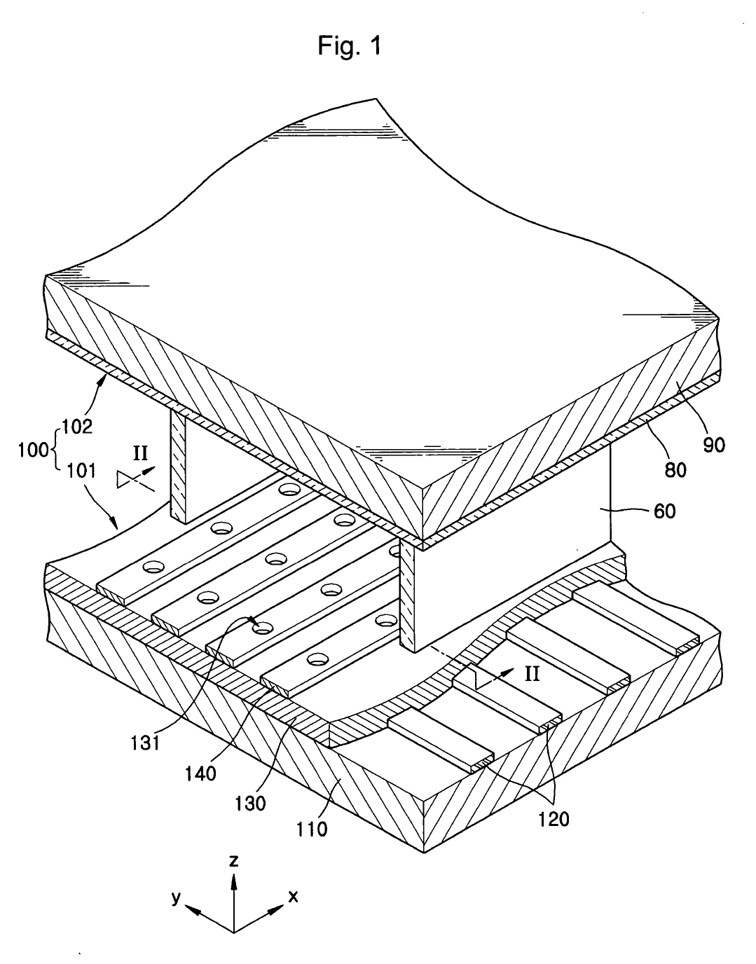

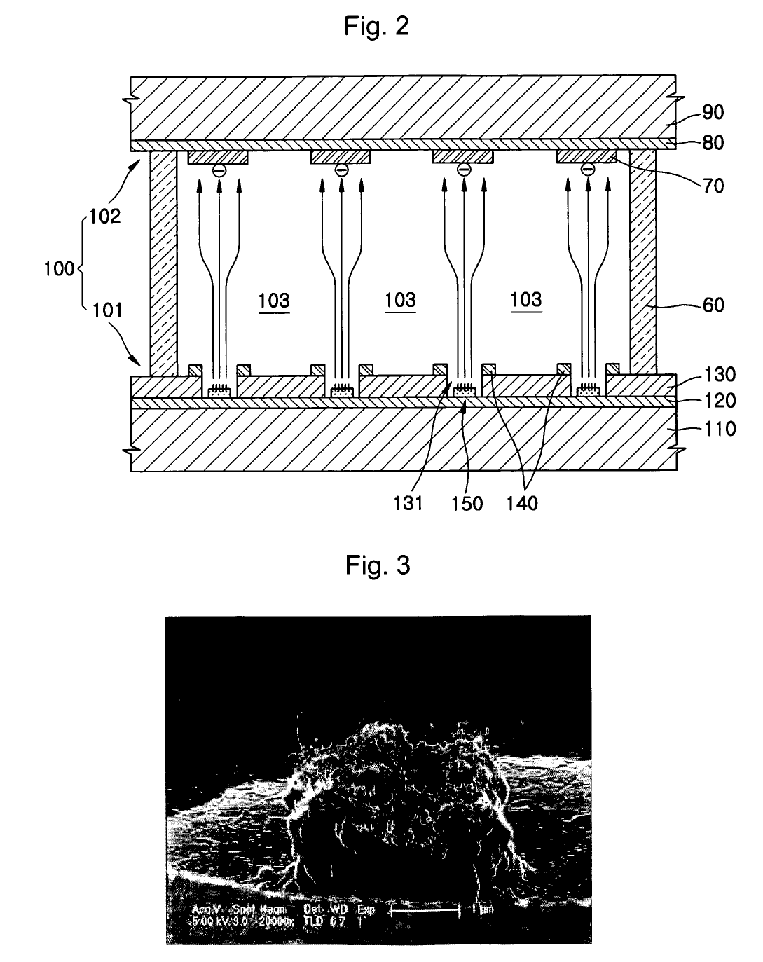

FIGS. 1 and 2 are views of an electron emission display apparatus 100 including an electron emission source. Referring to FIGS. 1 and 2, the electron emission display apparatus 100 includes an electron emission device 101, a front panel 102 which faces the electron emission device 101 to thereby form an emission space 103 that is vacuum therebetween, and spacers 60 maintaining a distance between the electron emission device 101 and the front panel 102.

The electron emission device 101 includes a first substrate 110, gate electrodes 140 and cathodes 120 crossing each other on the first substrate 110, and an insulating layer 130 that is interposed between the gate electrodes 140 and the cathodes 120 and electrically insulates the cathodes 120 from the gate electrodes 140. The insulating layer 130 is formed using the composition for forming an insulating layer according to an embodiment of the present invention, and has a thickness of less than 5 micrometers and uniformity.

Electron emission source holes 131 are formed at the junctions of the gate electrodes 140 and the cathodes 120, and electron emission sourced 150 are formed in the electron emission source holes 131. The electron emission sources 150 are formed using the composition for forming an electron emission source according to an embodiment of the present invention. The electron emission sources 150 have high adhesiveness after being sintered, and thus a more reliable product can be obtained.

The front panel 102 includes a second substrate 90, an anode 80 formed on a lower surface of the second substrate 90, and a fluorescent layer 70 located on a lower surface of the anode 80.

The present invention will be described in further detail with reference to the following examples. These examples are for illustrative purposes only and are not intended to limit the scope of the present invention.

### EXAMPLE 1

To prepare glass frit, PbO(60 wt %)—B₂O₃(10 wt %)—SiO₂(25 wt %)—Al₂O₃(5 wt %) based glass frit was melted using plasma flame of 400° C., the melted glass frit was ejected in an atmospheric pressure chamber to obtain powder having an average particle diameter of 100 to 500 nanometers. 100 parts by weight of the obtained glass frit, 0.5 parts by weight of a polycarboxylic acid based polymer surfactant as a dispersant, 25 parts by weight of a copolymer prepared by copolymerizing 2-ethylhexylmetacrylate and 2-hydroxyethylmetacrylate in a mole ratio of 95:5 as a binder, 2 parts by weight of adaphsandi-2-ethylhexyl as a plasticizer, 40 parts by weight of a mixed solvent of ethyl acetic acid and methylisobutylketone in 1:1 as a solvent were mixed by stirring to prepare a composition for forming an insulating layer.

The composition was screen printed on a glass substrate (50 mm×50 mm) including a transparent electrode (ITO electrode) using a mesh-shaped pattern mask, and then loaded into a heating pot to sinter at 500° C. for 15 minutes. As a result, an insulating layer having a thickness of 3 micrometers was obtained. Subsequently, a Cr gate electrode is formed.

### EXAMPLE 2

In order to prepare glass frit, PbO(60 wt %)—B₂O₃(10 wt %)—SiO₂(25 wt %)—Al₂O₃(5 wt %) based glass frit was melted using plasma flame of 400° C., and then the melted glass frit was ejected in an atmospheric pressure chamber to obtain a glass frit powder having an average particle diameter of 300 nanometers. 1 g of the obtained glass frit, 1 g of carbon nanotube powder (iljinnanotech Co., MWNT), 8 g of an acryl resin (produced by Elvacite Co.), 5 g of a photosensitive resin (TMPTA, Aldrich Co.), and 5 g of an photo initiator (HS-188, produced by Dongyang Ink Co.) were added to 40 g of terpineol, and the resultant solution was mixed. Then, 0.15 g, of Al having an average particle diameter of 15 nm was added to the mixture to prepare a composition for forming an electron emission source having a viscosity of 30,000 cps. The composition was printed on an electron emission source forming region of the substrate including a Cr gate electrode, an insulating layer, and an ITO electrode, and then an exposure energy of 2,000 mJ/cm² of a parallel light exposure device was irradiated to the composition through a pattern mask. Then, the composition was developed using acetone, and then sintered at 450° C. in the presence of nitrogen gas. As a result, an electron emission source was prepared. Subsequently, the substrate including the fluorescent layer and ITO electrode as an anode was disposed facing a substrate on which the electron emission source is formed. Then, spacers are formed between both substrates to maintain an interval therebetween. As a result, an electron emission device was manufactured

Experimental Example

An SEM image of a section of the insulating layer obtained according to Example 1 was shown in FIG. 3. As shown in FIG. 3, by using glass frit having a nanostructure, an insulating layer having a small thickness and uniformity was able to be obtained.

In addition, it was found that when the glass frit was added to the electron emission source, glass frit flowed during the sintering process and thus the bonding of the nano carbon emission source was enhanced.

By using a composition for forming an insulating layer including glass frit having an average particle diameter of nanometers according to the present invention, an insulating layer having a small thickness and high uniformity can be obtained. In addition, by using a composition for forming an electron emission source including glass frit having an average particle diameter of nanometers according to the present invention, an electron emission source that shows an enhanced adhesive force after being sintered can be obtained. Accordingly, an electron emission device including the insulating layer and/or the electron emission source has high reliability and improved uniformity.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A composition for forming an insulating layer, comprising:
glass frit having an average particle diameter of nanometers;
a dispersant;
a solvent; and
a binder.

2. The composition of claim 1, wherein the average particle diameter of the glass frit is in the range of 1 to 1,000 nm.

3. The composition of claim 1, wherein the average particle diameter of the glass frit is in the range of 10 to 100 nm.

4. The composition of claim 1, wherein the glass frit is obtained by plasma spraying.

5. The composition of claim 1, wherein the glass frit is spherical.

6. The composition of claim 1, wherein the glass frit comprises at least one glass frit selected from the group consisting of PbO—B₂O₃-based glass frit, PbO—B₂O₃—SiO₂-based glass frit, PbO—B₂O₃—SiO₂—Al₂O₃-based glass frit, ZnO—B₂O₃—SiO₂-based glass frit, PbO—ZnO—B₂O₃—SiO₂-based glass frit, Na₂O—B₂O₃—SiO₂-based glass frit, and BaO-CaO—SiO₂-based glass frit.

7. The composition of claim 1, wherein the dispersant has an amount of 0.01 to 10 parts by weight and the binder has an amount of 1 to 50 parts by weight, based on 100 parts by weight of the glass frit.

8. The composition of claim 1, wherein the dispersant comprises at least one agent selected from the group consisting of anionic surfactant, cationic surfactant, nonionic surfactant, polycarboxylic acid polymer surfactant, a polyetherester acid amine salt, and silane coupling agent.

9. The composition of claim 1, wherein the binder comprises at least one resin selected from the group consisting of a cellulose-based resin, an acryl-based resin, and a vinyl-based resin.

10. An insulating layer formed using the composition of claim 1.

11. The insulating layer of claim 10, wherein the thickness of the insulating layer is in the range of 2-10 microns.

12. A composition for forming an electron emission source, comprising:
glass frit having an average particle diameter of nanometers;
a carbonaceous material; and
a vehicle.

13. The composition of claim 12, wherein the average particle diameter of the glass frit is in the range of 1 to 1,000 nm.

14. The composition of claim 12, wherein the average particle diameter of the glass frit is in the range of 10-100 nm.

15. The composition of claim 12, wherein the glass frit is obtained by plasma spraying.

16. The composition of claim 12, wherein the glass frit is spherical.

17. The composition of claim 12, wherein the glass frit comprises at least one glass frit selected from the group consisting of PbO—B₂O₃-based glass frit, PbO—B₂O₃—SiO₂-based glass frit, PbO—B₂O₃—SiO₂—Al₂O₃-based glass frit, ZnO—B₂O₃—SiO₂-based glass frit, PbO—ZnO—B₂O₃—SiO₂-based glass frit, Na₂O—B₂O₃—SiO₂-based glass frit, and BaO-CaO—SiO₂-based glass frit.

18. The composition of claim 12, wherein the carbonaceous material has an amount of 0.1 to 200 parts by weight and the vehicle has an amount of 150 to 2,000 parts by weight, based on 100 parts by weight of glass frit.

19. The composition of claim 12, wherein the carbonaceous material is a carbon nanotube.

20. The composition of claim 12, wherein the vehicle comprises a polymer and an organic solvent.

21. The composition of claim 20, wherein the polymer comprises at least one resin selected from the group consisting of a cellulose-based resin, an acryl-based resin, and a vinyl-based resin.

22. The composition of claim 20, wherein the organic solvent comprises at least one solvent selected from the group consisting of butyl carbitol acetate, terpineol, toluene, texanol, and butyl carbitol.

23. The composition of claim 12, further comprising at least one substance selected from the group consisting of an inorganic adhering component, an organic adhering component, and a metal having a low melting point.

24. The composition of claim 12, further comprising at least one selected from the group consisting of filler, a photosensitive resin, viscosity improver, and resolution improver.

25. An electron emission source formed using the composition of claim 12.

26. An electron emission device comprising:
a first substrate;
a plurality of cathodes on the first substrate;
a plurality of gate electrodes crossing the cathodes, the plurality of cathodes and the plurality of gate electrodes having electron emission source holes at the junctions of the plurality of cathodes and the plurality of gate electrodes;
an insulating layer insulating the cathodes and the gate electrodes, the insulating layer containing glass frit having an average particle diameter of nanometers; and
electron emission sources in the electron emission source holes.

27. An electron emission device comprising:
a first substrate;
a plurality of cathodes on the first substrate;
a plurality of gate electrodes crossing the cathodes, the plurality of cathodes and the plurality of gate electrodes having electron emission source holes at the junctions of the plurality of cathodes and the plurality of gate electrodes;
an insulating layer insulating the cathodes and the gate electrodes; and
electron emission sources in the electron emission source holes, the electron emission sources containing glass frit having an average particle diameter of nanometers.
